(19) United States
(12) Patent Application Publication
(10) Pub. No.: US 2016/0139662 A1
(43) Pub. Date: May 19, 2016

(54) CONTROLLING A VISUAL DEVICE BASED ON A PROXIMITY BETWEEN A USER AND THE VISUAL DEVICE

(71) Applicant: Sachin Dabhade, Austin, TX (US)

(72) Inventor: Sachin Dabhade, Austin, TX (US)

(21) Appl. No.: 14/542,081

(22) Filed: Nov. 14, 2014

(51) Int. Cl. G06F 3/01; G06K 9/52; G06K 9/00

(52) U.S. Cl. CPC G06F 3/012; G06K 9/00288; G06K 9/52; G06K 9/00268

(57) ABSTRACT

A visual device may be configured to control a display of the visual device based on a proximity to a user of the visual device. Accordingly, the visual device receives an input associated with a user of the visual device. The visual device determines an identity of the user of the visual device based on the input associated with the user. The visual device configures the visual device based on the identity of the user. The visual device determines that the visual device configured based on the identity of the user is located at an impermissible distance from a portion of the face of the user. The visual device causes a display of the visual device to interrupt presentation of a user interface based on the determining that the visual device is located at the impermissible distance from the portion of the face of the user.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2014, All Rights Reserved.

### TECHNICAL FIELD

The present application relates generally to processing data and, in various example embodiments, to systems and methods for controlling a visual device based on a proximity between a user and the visual device.

### BACKGROUND

As a result of the proliferation of mobile devices, such as smart phones and tablets, it is not unusual to see children utilizing such mobile devices to play games or read books. While playing or reading on mobile devices, a child may sometimes bring the mobile devices very close to the child's eyes. Similarly, the child may get too close to a television while watching a program. This may increase the child's eye pressure and may cause eye strain. As a result of a prolonged use of visual devices located too close to the child's eyes, the child may eventually require eye glasses.

### BRIEF DESCRIPTION OF THE DRAWINGS

Some embodiments are illustrated by way of example and not limitation in the figures of the accompanying drawings.

FIG. 1 is a network diagram depicting a client-server system, within which some example embodiments may be deployed.

FIG. 2 is a diagram illustrating a user utilizing a visual device, according to some example embodiments.

FIG. 3 is a block diagram illustrating components of the visual device, according to some example embodiments.

FIG. 4 is a flowchart illustrating a method for controlling a visual device based on a proximity to a user of the visual device, according to some example embodiments.

FIG. 5 is a flowchart illustrating a method for controlling a visual device based on a proximity to a user of the visual device in more detail, according to some example embodiments

FIG. 6 is a flowchart illustrating a method for controlling a visual device based on a proximity to a user of the visual device in more detail, and represents additional steps of the method illustrated in FIG. 4, according to some example embodiments.

FIG. 7 is a flowchart illustrating a method for controlling a visual device based on a proximity to a user of the visual device, and represents additional steps of the method illustrated in FIG. 4, according to some example embodiments.

FIG. 8 is a flowchart illustrating a method for controlling a visual device based on a proximity to a user of the visual device in more detail, according to some example embodiments.

FIG. 9 is a block diagram illustrating a mobile device, according to some example embodiments.

FIG. 10 depicts an example mobile device and mobile operating system interface, according to some example embodiments.

FIG. 11 is a block diagram illustrating an example of a software architecture that may be installed on a machine, according to some example embodiments.

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems for controlling a visual device based on a proximity to a user of the visual device are described. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In some example embodiments, to maintain the health of the eyes of a user of a visual device, it is recommended that the user keep a minimum distance between the visual device and the eyes of the user. The visual device (hereinafter, also “the device”) is a device that includes or utilizes a screen, such as a mobile device (e.g., a smart phone or a tablet), a TV set, a computer, a laptop, and a wearable device. A user, a parent of the user, or a person acting in loco parentis (e.g., a teacher, a guardian, a grandparent, or a babysitter) may wish to configure the visual device such that the visual device prompts the user to maintain a distance between the visual device and the eyes of the user, that is considered safe for the eyes of the user.

According to various example embodiments, a machine (e.g., a visual device) may receive an input associated with a user of the visual device. The input associated with the user may include, for example, login data, biometric data, an image associated with the user (e.g., a photograph of the user), and voice signature data. The machine may determine an identity of the user of the visual device based on the input associated with the user. For example, the machine may include a smart phone. The smart phone may include a camera that is configured to automatically capture an image of the user of the smart phone in response to the user activating the smart phone. Based on the captured image of the user, the smart phone may determine the identity of the user by comparing the captured image with stored images of identified users. In some instances, one or more image processing algorithms are utilized to identify the user based on the captured image of the user.

In example embodiments, the machine configures the visual device based on the identity of the user. In some instances, the configuring of the visual device based on the identity of the user may be especially beneficial when more than one user is allowed to utilize the visual device. The configuring of the visual device based on the identity of the user facilitates customization of a range of functionalities of the visual device according to specific rules that pertain to certain users of the device. For example, a first user (e.g., a parent) may select a range of permissive rules for a number of functionalities associated with the visual device. The first user may, for instance, choose to not enforce a rule that specifies a predetermined threshold proximity value between the eyes of the user and the visual device. Alternatively, the first user may modify the threshold proximity value by specifying a different, less restrictive distance value. Further, the first user may select, for a second user (e.g., a child), one or more rules for a number of functionalities associated with the visual device, that are more restrictive. For instance, the parent indicates (e.g., in a user interface of the visual device) that the second user is a child, and the visual device strictly applies one or more control rules for controlling the visual device.

The machine determines that the visual device configured based on the identity of the user is located at an impermissible distance from a portion of the face of the user. An impermissible distance may be a distance that is less than a minimum distance value identified as safe for the eyes of the user. In some instances, the determining that the visual device is located at the impermissible distance from a portion of the face of the user is based on the input associated with the user. In other instances, the determining that the visual device is located at the impermissible distance from a portion of the face of the user is based on a further (e.g., a second or additional) input associated with the user. For example, the input may be login data of a first user and the further input may be an image (e.g., a photograph) of the first user captured by a camera of the visual device after the first user has logged in.

The machine may cause, using one or more hardware processors, an interruption of a display of data in a user interface of the visual device based on the determining that the visual device is located at the impermissible distance from the portion of the face of the user. In some example embodiments, the causing of the interruption of the display includes switching off the display of the visual device. In other embodiments, the causing of the interruption of the display includes providing a prompt to the user indicating that the distance between the user and the visual device is less than a desired minimum distance. In some instances, the visual device generates a specific signal (e.g., a sound signal or a vibration signal) to indicate that the distance between the user and the visual device is less than a desired minimum distance. In response to the specific signal, the user should move the visual device to a distance identified as safer for the eyes of the user. In some example embodiments, the visual device re-determines the distance between the visual device and the user, and activates its display based on determining that the distance value between the visual device and the user exceeds the desired minimum distance value.

In some example embodiments, one or more of the functionalities described above are provided by an application executing on the visual device. For instance, an application that facilitates controlling the visual device based on an identified proximity between the visual device and the user of the device executes as a background daemon on a mobile device while a foreground or primary application is a video game played by the user.

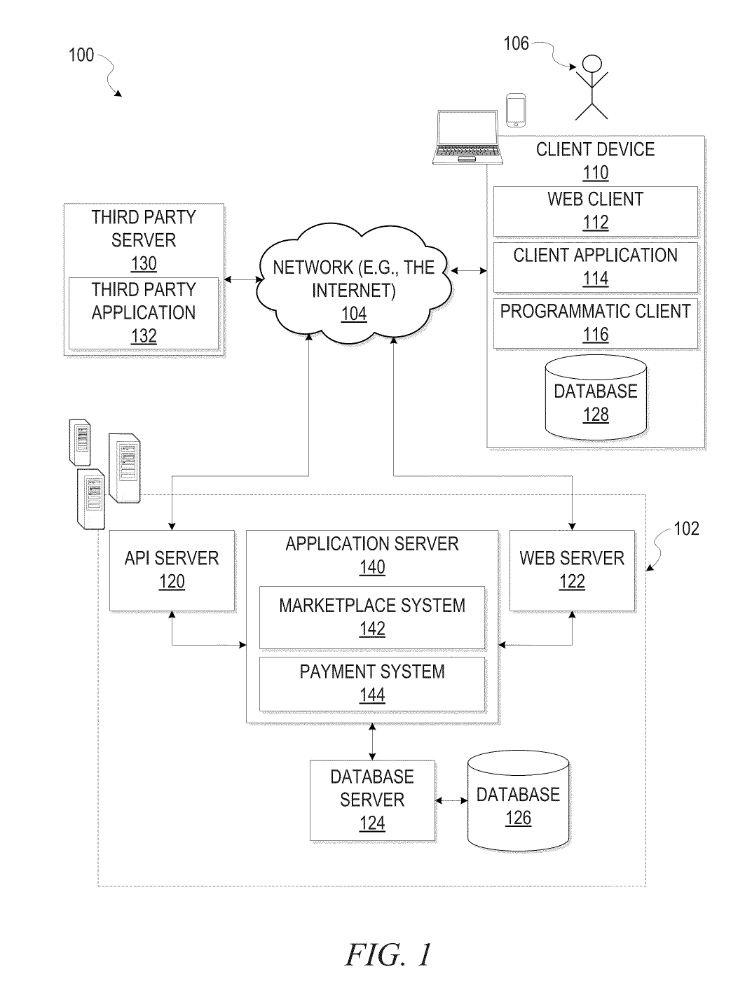

With reference to FIG. 1, an example embodiment of a high-level client-server-based network architecture 100 is shown. A networked system 102 provides server-side functionality via a network 104 (e.g., the Internet or wide area network (WAN)) to a client device 110. In some implementations, a user (e.g., user 106) interacts with the networked system 102 using the client device 110 (e.g., a visual device). FIG. 1 illustrates, for example, a web client 112 (e.g., a browser, such as the Internet Explorer® browser developed by Microsoft® Corporation of Redmond, Wash. State), client application 114, and a programmatic client 116 executing on the client device 110. The client device 110 may include the web client 112, the client application 114, and the programmatic client 116 alone, together, or in any suitable combination. The client device 110 may also include a database (e.g., a mobile database) 128. The database 128 may store a variety of data, such as a list of contacts, calendar data, geographical data, or one or more control rules for controlling the client device 110. The database 128 may also store baseline models of faces of users of the visual device. The baseline models of the faces of the users may be based on images captured of the faces of the users at a time of configuring the client application 114 or at a time of registering (e.g., adding) a new user of the visual device 110 with the client application 114. Although FIG. 1 shows one client device 110, in other implementations, the network architecture 100 comprises multiple client devices.

In various implementations, the client device 110 comprises a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMax) network, another type of network, or any suitable combination thereof.

In some example embodiments, the client device 110 includes one or more applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, and e-commerce site apps (also referred to as “marketplace apps”). In some implementations, the client application 114 includes various components operable to present information to the user and communicate with networked system 102.

In various example embodiments, the user (e.g., the user 106) comprises a person, a machine, or other means of interacting with the client device 110. In some example embodiments, the user 106 is not part of the network architecture 100, but interacts with the network architecture 100 via the client device 110 or another means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user may interact with the networked system 102 using the client device 110.

An Application Program Interface (API) server 120 and a web server 122 may be coupled to, and provide programmatic and web interfaces respectively to the application server 140. The application server 140 may host a marketplace system 142 or a payment system 144, each of which may comprise one or more modules or applications, and each of which may be embodied as hardware, software, firmware, or any suitable combination thereof. The application server 140 is, in turn, shown to be coupled to a database server 124 that facilitates access to an information storage repository or database 126. In an example embodiment, the database 126 is a storage device that stores information to be posted (e.g., publications or listings) to the marketplace system 142. The database 126 may also store digital goods information in accordance with some example embodiments.

Additionally, a third party application 132, executing on a third party server 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

The marketplace system 142 may provide a number of publication functions and services to the users that access the networked system 102. The payment system 144 may likewise provide a number of functions to perform or facilitate payments and transactions. While the marketplace system 142 and payment system 144 are shown in FIG. 1 to both form part of the networked system 102, it will be appreciated that, in alternative embodiments, each system 142 and 144 may form part of a payment service that is separate and distinct from the networked system 102. In some example embodiments, the payment system 144 may form part of the marketplace system 142.

Further, while the client-server-based network architecture 100 shown in FIG. 1 employs a client-server architecture, the present inventive subject matter is, of course, not limited to such an architecture, and may equally well find application in a distributed, or peer-to-peer, architecture system. The various systems of the applications server 140 (e.g., the marketplace system 142 and the payment system 144) may also be implemented as standalone software programs, which may not necessarily have networking capabilities.

The web client 112 may access the various systems of the networked system 102 (e.g., the marketplace system 142) via the web interface supported by the web server 122. Similarly, the programmatic client 116 and client application 114 may access the various services and functions provided by the networked system 102 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

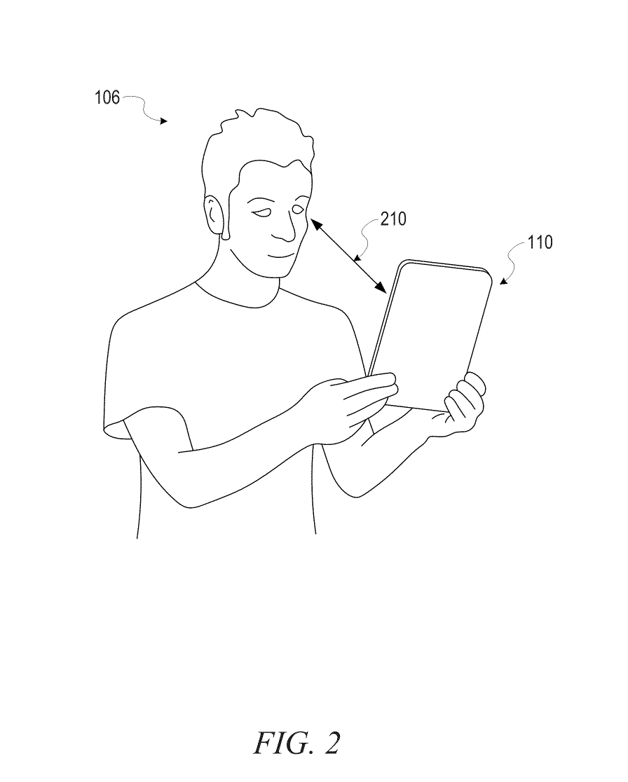

FIG. 2 is a diagram illustrating a user utilizing a visual device, according to some example embodiments. As shown in FIG. 2, the user 106 utilizes a visual device (e.g., a tablet) 110 to view information presented to the user 106 in a display (e.g., a user interface) of the visual device 110.

In some example embodiments, at certain times (e.g., at pre-determined intervals of time), the visual device 110 identifies (e.g., measures) a distance 210 between the visual device 110 and a portion of the face of the user (e.g., the eyes of the user) 106. If the visual device 110 determines that the distance 210 between the visual device 110 and the portion of the face of the user is less than a threshold value (e.g., eight inches), then the visual device 110 communicates to the user 106 that the user's face is too close to the display of the visual device 110, for example, by switching off the display of the visual device 110. This should cause the user 106 to move the visual device 110 to the desirable distance (e.g., a distance that exceeds the threshold value).

The visual device 110 may re-evaluate the distance between the mobile device and the portion of the face of the user 106 at a later time. If the distance 210 is determined (e.g., by the visual device 110) to exceed the threshold value, the visual device 110 may activate the display of the visual device 110.

The distance 210 between the visual device 110 and a part of the face of the user 106 may be determined in a variety of ways. In some example embodiments, an image processing algorithm is used to compare a baseline image of the face of the user, captured when the face of the user 106 is located at the desired threshold distance, and a later-captured image of the face of the user (e.g., a comparison based on size of the face or feature of the face). The images of the face of the user 106 may be captured by a camera associated with the visual device 110. A module of the visual device 110 may control the camera based on causing the camera to capture images of the users of the visual device. Based on analyzing (e.g., comparing) a size of one or more facial features of the user 106 in the baseline image and one or more corresponding facial features of the user 106 in the image of the face of the user, captured at a later time, the image processing algorithm may determine that, at the later time, the face of the user 106 was located at an impermissible distance (e.g., closer) with respect to the visual device 110. For instance, the image processing algorithm may determine that one or more of the facial features of the user 106 are larger in the later image of the face of the user 106 as compared to the baseline image of the face of the user.

In certain example embodiments, one or more sensors associated with (e.g., included in) the visual device 110 may be used to determine the distance 210 between the visual device 110 and the user 106. For example, a proximity sensor included in the visual device 110 detects how close the screen of the visual device is to the face of the user 106. In another example, an ambient light sensor included in the visual device 110 determines how much light is available in the area surrounding the visual device 110, and determines whether the visual device 110 is too close to the face of the user 106 based on the amount of light available in the area surrounding the visual device 110.

According to example embodiments, based on the use of depth tracking technology, for example, implemented in depth sensors (e.g., the Microsoft™ Kinect™, hereinafter, “Kinect”, stereo cameras, mobile devices, and any other device that may capture depth data) spatial data can be gathered about objects (e.g., the user) located in the physical environment external to the depth sensor. For example, an infrared (IR) emitter associated with the visual device 110 projects (e.g., emits or sprays out) beams of IR light into surrounding space. The projected beams of IR light may hit and reflect off objects that are located in their path (e.g., the face of the user). A depth sensor associated with the visual device 110 captures (e.g., receives) spatial data about the surroundings of the depth sensor based on the reflected beams of IR light. Examples of such spatial data include the location and shape of the objects within the room where the spatial sensor is located. In example embodiments, based on measuring how long it takes the beams of IR light to reflect off objects they encounter in their path and be captured by the depth sensor, the visual device 110 determines the distance 210 between the depth sensor associated with the visual device 110 and the face of the user 106.

In other example embodiments, the visual device 110 acoustically determines the distance 210 between the visual device 110 and the user 106. The visual device 110 may be configured to utilize propagation of sound waves to measure the distances 210 between the visual device 110 and the user 106.

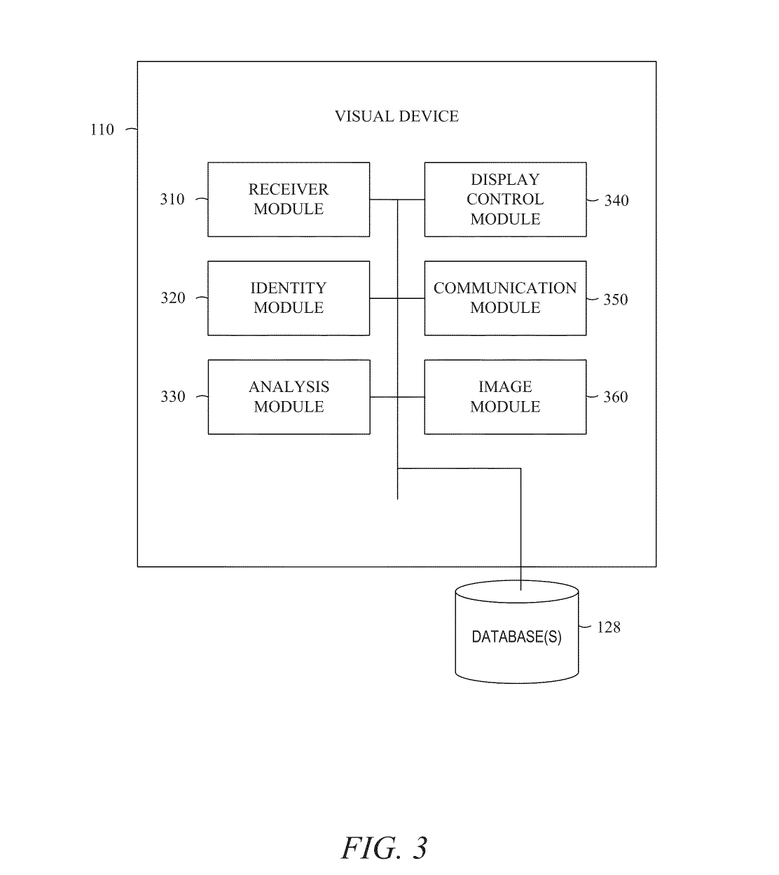

FIG. 3 is a block diagram illustrating components of the visual device 110, according to example embodiments. As shown in FIG. 3, the visual device 110 may include a receiver module 310, an identity module 320, an analysis module 330, a display control module 340, a communication module 350, and an image module 360, all configured to communicate with each other (e.g., via a bus, shared memory, or a switch).

The receiver module 310 may receive an input associated with a user of a visual device. The visual device may include a mobile device (e.g., a smart phone, a tablet, or a wearable device), a desktop computer, a laptop, a TV, or a game console.

The identity module 320 may determine an identity of the user of the visual device based on the input associated with the user. The identity module 320 may also configure the visual device based on the identity of the user.

The analysis module 330 may determine that the visual device configured based on the identity of the user is located at an impermissible distance from a portion of a face of the user. In some example embodiments, the analysis module 330 determines that the visual device is located at the impermissible distance from the portion of the face of the user based on comparing one or more facial features in a captured image that represents the face of the user of the visual device to one or more corresponding facial features in a baseline model of the face of the user.

The display control module 340 may cause a display of the visual device to interrupt presentation of a user interface based on the determining that the visual device is located at the impermissible distance from the portion of the face of the user. For example, the display control module 340 causes a display controller (e.g., a video card or a display adapter) of the visual device to turn the display off or provides a signal to the user that signifies that the user is too close to the visual device.

The communication module 350 may communicate with the user of the visual device. For example, the communication module 350 causes the user to position the face of the user at a distance equal to the threshold proximity value by presenting (e.g., displaying or voicing) a message to the user of the visual device. The message may communicate one or more instructions for positioning the visual device in relation to the face of the user such that the distance between a portion of the face of the user and the visual device is equal to the threshold proximity value.

The image module 360 may cause a camera associated with the visual device to capture images of the face of the user at different times when the user utilizes the visual device. For example, the image module 360 causes a camera of the visual device to capture an image of the face of the user located approximately at the distance equal to the threshold proximity value. The image module 360 generates a baseline model of the face of the user based on the captured image.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 128.

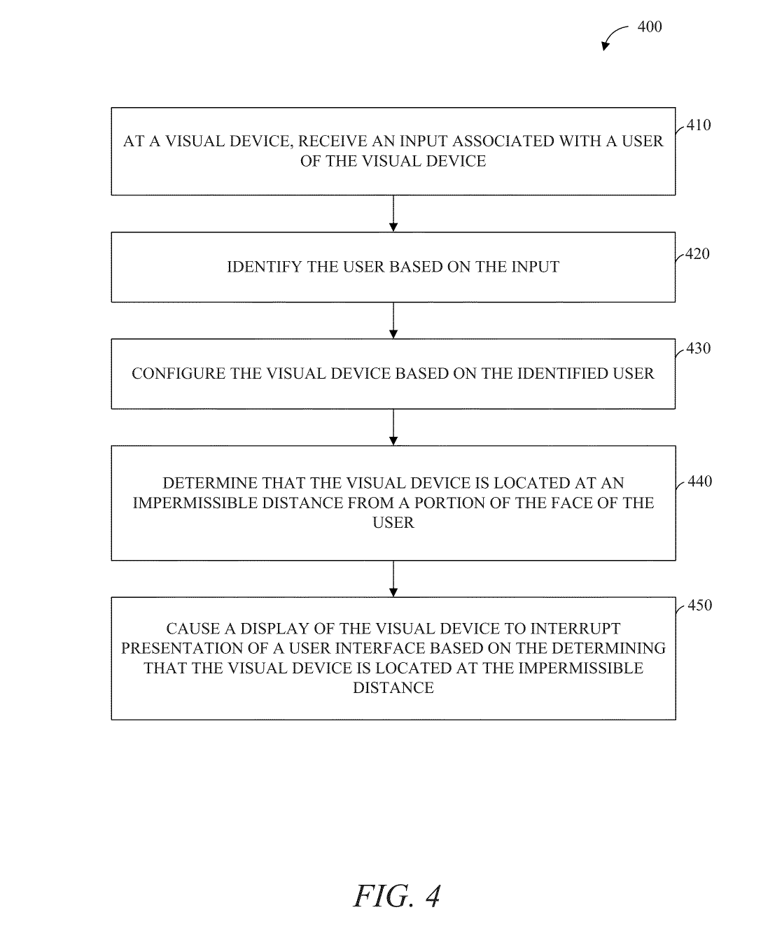

FIGS. 4-8 are flowcharts illustrating a method for controlling a visual device based on a proximity between a user and the visual device, according to some example embodiments. Operations in the method 400 may be performed using modules described above with respect to FIG. 3. As shown in FIG. 4, the method 400 may include one or more of operations 410, 420, 430, 440, and 450.

At operation 410, the receiver module 310 receives an input associated with a user of a visual device. In example embodiments, the input received at the visual device includes a visual input that represents one or more facial features of the user of the visual device. The determining of the identity of the user may be based on the one or more facial features of the user. Accordingly, the input received at the visual device includes biometric data associated with the user. The biometric data may be captured by the visual device (e.g., by a sensor of the visual device). The determining of the identity of the user may be based on the biometric data associated with the user of the visual device. For example, the camera of a visual device may be utilized to capture face or iris data for face or iris recognition, the microphone of the visual device may be used to capture voice data for voice recognition, and the keyboard of the visual device may be used to capture keystroke dynamics data for typing rhythm recognition.

Additionally or alternatively, the input received at the visual device may include login data associated with the user. The login data may be entered at the visual device by the user of the visual device. As such, the determining of the identity of the user may be based on the login data associated with the user.

At operation 420, the identity module 320 determines the identity of the user of the visual device based on the input associated with the user. The identity module 320, in some instances, may identify the user based on biometric data associated with the user, captured utilizing a sensor or a camera associated with the visual device. Biometric data may include biometric information derived from measurable biological or behavioral characteristics. Examples of common biological characteristics used for authentication of users are fingerprints, palm or finger vein patterns, iris features, voice patterns, and face patterns. Behavioral characteristics such as keystroke dynamics (e.g., a measure of the way that a user types, analyzing features such as typing speed and the amount of time the user spends on a given key) may also be used to authenticate the user. The identity module 320 may determine the identity of the user based on a comparison of captured biometric data of a user to one or more sets of biometric data previously obtained for one or more users of the visual device (e.g., at an application configuration time). In other instances, the identity module 320 may determine the identity of a user based on a comparison of login data provided by the user to one or more sets of login data previously obtained for one or more users of the visual device (e.g., at an application configuration time).

At operation 430, the identity module 320 configures the visual device based on the identity of the user. In some instances, the configuring of the visual device based on the identity of the user may be especially beneficial when more than one user is allowed to utilize the visual device. The configuring of the visual device based on the identity of the user may allow customization of one or more functionalities of the visual device according to specific rules that pertain to certain users of the device. For example, based on determining the identity of a particular user (e.g., a child John), the identity module 320 identifies a control rule for controlling the visual device, that specifies that a minimum distance between the user and the visual device should be enforced by the visual device when the particular user, the child John, uses the visual device. In some instances, the control rule is provided (or modified) by another user (e.g., a parent of the specific user) of the visual device at a time of configuring the visual device or an application of the visual device.

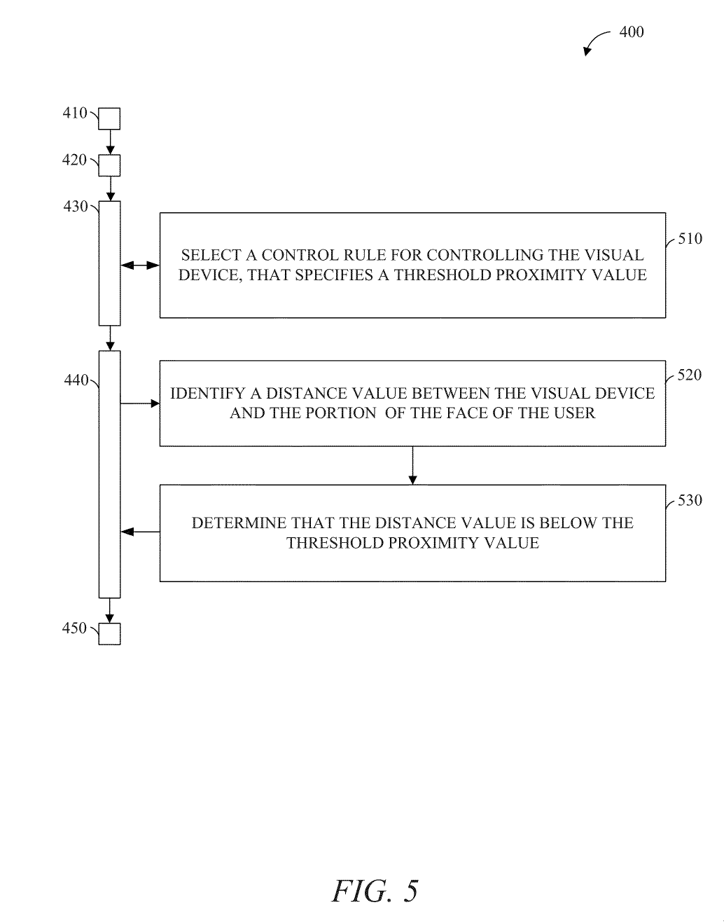

According to another example, based on determining the identity of another user (e.g., a parent Amy), the identity module 320 identifies another control rule for controlling the visual device, that specifies that a minimum distance between the user and the visual device should not be enforced by the visual device when the particular user, the parent Amy, uses the visual device. In some instances, the control rule is provided (or modified) by the other user of the visual device at a time of configuring the visual device or an application of the visual device. Operation 430 will be discussed in more detail in connection with FIG. 5 below.

At operation 440, the analysis module 330 determines that the visual device configured based on the identity of the user is located at an impermissible distance from a portion of the face of the user. The analysis module 330 may, for instance, determine that the visual device is located at the impermissible distance from the portion of the face of the user based on a comparison of one or more facial features in a captured image of the portion of the face (e.g., an iris of an eye) of the user and one or more corresponding facial features in a baseline image of the portion of the face of the user. Operation 440 will be discussed in more detail in connection with FIGS. 5, 6, and 8 below.

At operation 450, the display control module 340 causes a display of the visual device to interrupt presentation of a user interface based on the determining that the visual device is located at the impermissible distance from the portion of the face of the user. For example, the display control module 340 sends a signal to a display controller of the visual device, that triggers the display of the visual device to dim (or turn off) in response to the signal.

Additionally or alternatively, the display control module 340 may control a haptic component (e.g., a vibratory motor) of the visual device. For example, the display control module 340 may control a vibratory motor of the visual device by sending a signal to the vibratory motor to trigger the vibratory motor to generate a vibrating alert for the user of the visual device. The vibrating alert may indicate (e.g., signify) that the user is too close to the visual device.

Additionally or alternatively, the display control module 340 may control an acoustic component (e.g., a sound card) of the visual device. For example, the display control module 340 may control the sound card of the visual device by sending a signal to the sound card to trigger the sound card to generate a specific sound. The specific sound may indicate (e.g., signify) that the user is too close to the visual device. Further details with respect to the operations of the method 400 are described below with respect to FIGS. 5-8.

As shown in FIG. 5, the method 400 may include one or more of operations 510, 520, and 530, according to some example embodiments. Operation 510 may be performed as part (e.g., a precursor task, a subroutine, or a portion) of operation 430, in which the identity module 320 configures the visual device based on the identity of the user.

At operation 510, the identity module 320 selects a control rule for controlling the visual device. The selecting of the control rule may be based on the identity of the user. The control rule may specify a threshold proximity value. In some example embodiments, the application that facilitates controlling the visual device based on an identified proximity between the visual device and the user of the device provides a default control rule for controlling the visual device. The default control rule may specify a predetermined minimum proximity value for the distance between a part of the face (e.g., an eye) of a user of the visual device and the visual device. In some instances, a user of the visual device may be allowed to modify one or more attributes of the default control rule. For example, a user, such as a parent, may select (or specify) a value for the threshold proximity value that is different (e.g., greater or smaller) than the threshold proximity value specified in the default control rule. Alternatively or additionally, the user may request the generation (e.g., by the application) of one or more control rules for one or more users of the visual device based on specific modifications to the default control rule. In some instances, the default control rule may be modified for each particular user of the visual device to generate a particular control rule applicable to the particular user. A particular control rule for controlling the visual device may be selected by the identity module 320 based on the determining of the identity of the user.

In example embodiments, a control rule for controlling the visual device may identify a type of signal to be used in communicating to the user that the visual device is too close to the visual device. In some instances, the control rule may indicate that an audio signal should be used to notify the user that the face of the user is located at an impermissible distance from the visual device. In other instances, the control rule may indicate that a vibrating alert should be used to communicate to the user that the face of the user is located at an impermissible distance from the visual device. Alternatively or additionally, the control rule may indicate that the visual device should cause a display of the visual device to interrupt presentation of a user interface to notify the user that the face of the user is located at an impermissible distance from the visual device. One or more control rules (e.g., a default control rule and/or a modified control rule) may be stored in a record of a database associated with the visual device (e.g., the database 128).

Operation 520 may be performed as part (e.g., a precursor task, a subroutine, or a portion) of operation 440, in which the analysis module 330 determines that the visual device configured based on the identity of the user is located at an impermissible distance from a portion of the face of the user. Accordingly, the analysis module 330 identifies a distance value between the visual device and the portion of the face of the user.

The distance value between the visual device and a part of the face of the user may be determined in a variety of ways. In some example embodiments, the analysis module 330 compares a baseline image of the face of the user, captured when the face of the user is located at the desired threshold distance, and a later-captured image of the face of the user (e.g., a comparison based on the size of the face or a feature of the face). The images of the face of the user may be captured by one or more cameras associated with the visual device. In some instances, the analysis module 330 may identify the distance value between the visual device and a portion of the face of the user based on comparing a distance between two features of the face of the user, identified based on the later-captured image of the user, and the corresponding distance between the two features of the face of the user, identified based on the baseline image of the face of the user.

In certain example embodiments, one or more sensors associated with (e.g., included in) the visual device may be used to gather data pertaining to the distance between the visual device and the user. For example, an ambient light sensor included in the visual device determines how much light is available in the area surrounding the visual device, and determines the distance between the visual device and the face of the user based on the amount of light available in the area surrounding the visual device.

According to another example, a proximity sensor (also “depth sensor”) associated with (e.g., included in) the visual device detects how close the screen of the visual device is to the face of the user. In some instances, the proximity sensor emits an electromagnetic field, and determines the distance between the visual device and the face of the user based on identifying a change in the electromagnetic field. In other instances, the proximity sensor emits a beam of infrared (IR) light, and determines the distance between the visual device and the face of the user based on identifying a change in the return signal. For example, based on the use of depth tracking technology implemented in a depth sensor (e.g., a Microsoft™ Kinect™), the depth sensor may gather spatial data about objects (e.g., the user) located in the physical environment external to the depth sensor. An infrared (IR) emitter associated with the visual device may project (e.g., emits or sprays out) beams of IR light into surrounding space. The projected beams of IR light may hit and reflect off objects (e.g., the face of the user) that are located in their path. The depth sensor captures (e.g., receives) spatial data about the surroundings of the depth sensor based on the reflected beams of IR light. Examples of such spatial data include the location and shape of the objects within the room where the spatial sensor is located. In example embodiments, based on measuring how long it takes the beams of IR light to reflect off objects they encounter in their path and be captured by the depth sensor, the visual device determines the distance between the depth sensor and the face of the user.

In other example embodiments, the visual device acoustically determines the distance between the visual device and the user based on utilizing propagation of sound waves. For example, an acoustic (e.g., sound generating) component associated with the visual device may generate a burst of ultrasonic sound to a local area where the user is located. The ultrasonic sound may be reflected off the face of the user back to an audio sensor of the visual device. The audio sensor may measure the time for the ultrasonic sound to return to the audio sensor. Based on the return time (and the speed of sound in the medium of the local area), the analysis module 330 may identify (e.g., determine, compute, or calculate) the distance value between the visual device and a portion of the face of the user.

Operation 530 may be performed after operation 520. At operation 530, the analysis module 330 determines that the distance value between the visual device and the portion of the face of the user is below the threshold proximity value. For example, the analysis module 330 determines that the distance value between the visual device and the portion of the face of the user is below the threshold proximity value based on a comparison between the identified distance value and the threshold proximity value specified in a control rule.

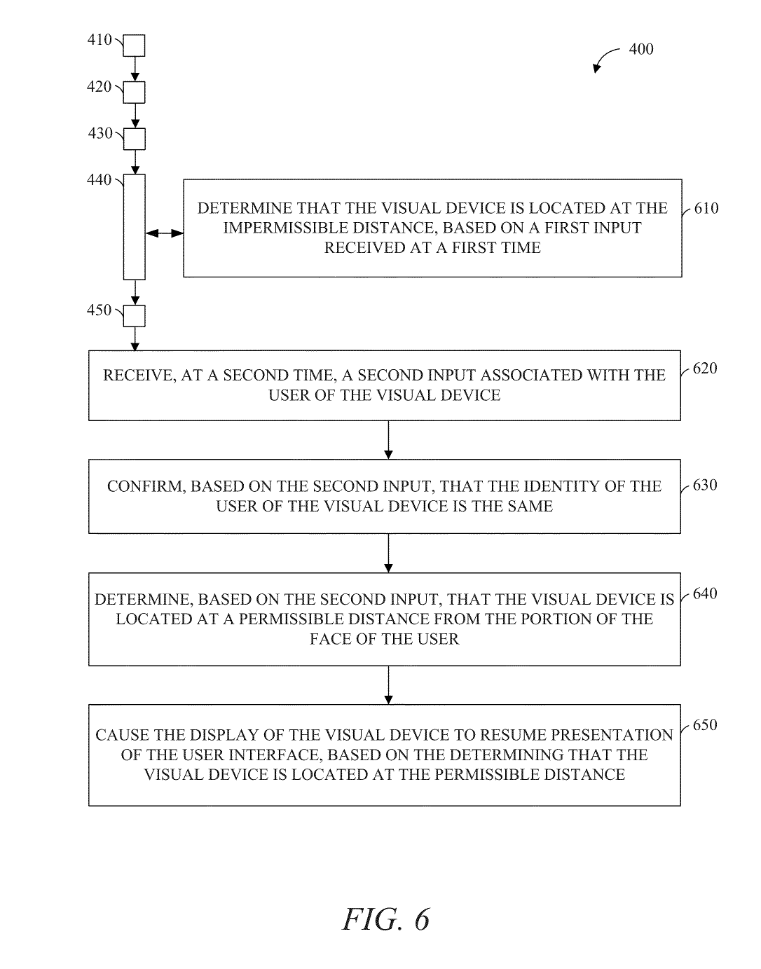

As shown in FIG. 6, the method 400 may include one or more of operations 610, 620, 630, 640, and 650, according to some example embodiments. Operation 610 may be performed as part (e.g., a precursor task, a subroutine, or a portion) of operation 440, in which the analysis module 330 determines that the visual device configured based on the identity of the user is located at an impermissible distance from a portion of the face of the user. At operation 610, the analysis module 330 determines that the visual device is located at the impermissible distance from the portion of the face of the user, based on a first input received at the first time. In some instances, the first input received at the first time is the input associated with the user of the visual device.

Operation 620 may be performed after the operation 450, in which the display control module 340 causes a display of the visual device to interrupt presentation of a user interface based on the determining that the visual device is located at the impermissible distance from the portion of the face of the user. At operation 620, the receiver module 310 receives, at a second time, a second input associated with the user of the visual device. The second input associated with the user may include, for example, login data, biometric data, an image associated with the user (e.g., a photograph of the user), and voice signature data.

Operation 630 may be performed after the operation 620. At operation 630, the identity module 320 confirms that the identity of the user of the visual device is the same. The confirming that the identity of the user of the visual device is the same may be based on the second input received at the second time. For example, the identity module 320 may confirm that the same user is using the visual device based on comparing the second input received at the second time and the first input received at the first time and that identifies the user.

Operation 640 may be performed after the operation 630. At operation 630, the analysis module 330 determines that the visual device is located at a permissible distance from the portion of the face of the user. The determining that the visual device is located at a permissible distance from the portion of the face of the user may be based on the second input received at the second time. For example, the analysis module 330 identifies a further distance between the visual device and the portion of the face of the user, based on the second input received at the second time, compares the further distance value and the threshold proximity value specified in a particular control rule applicable to the user identified as using the visual device, and determines that the further distance value does not fall below the threshold proximity value.

Operation 650 may be performed after the operation 640. At operation 650, the display control module 340 causes the display of the visual device to resume presentation of the user interface. The causing of the display of the visual device to resume presentation of the user interface may be based on the determining that the visual device is located at the permissible distance from the portion of the face of the user.

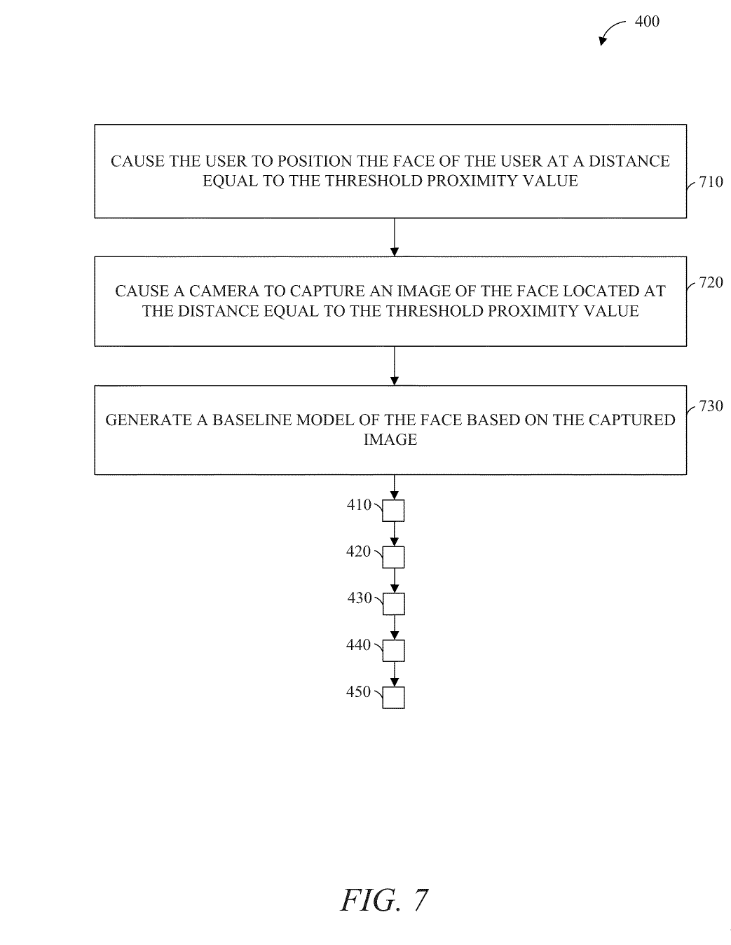

As shown in FIG. 7, the method 400 may include one or more of operations 710, 720, and 730, according to some example embodiments. Operation 710 may be performed before operation 410, in which the receiver module 310 receives an input associated with a user of a visual device. At operation 710, the communication module 350 causes the user to position the face of the user at a distance equal to the threshold proximity value. The communication module 350 may cause the user to position the face of the user at the distance equal to the threshold proximity value by presenting (e.g., displaying or voicing) a message to the user of the visual device. The message may communicate one or more instructions for positioning the visual device in relation to the face of the user such that the distance between a portion of the face of the user and the visual device is equal to the threshold proximity value.

Operation 720 may be performed after operation 710. At operation 720, the image module 360 causes a camera associated with the visual device to capture an image of the face of the user located approximately at the distance equal to the threshold proximity value. For example, the image module 360 may transmit a signal to a camera of the visual device to trigger the camera to capture an image of the face (or a part of the face) of the user.

Operation 730 may be performed after operation 720. At operation 730, the image module 360 generates a baseline model of the face of the user based on the captured image. In some example embodiments, the baseline model includes a baseline image of the face of the user that corresponds to the captured image.

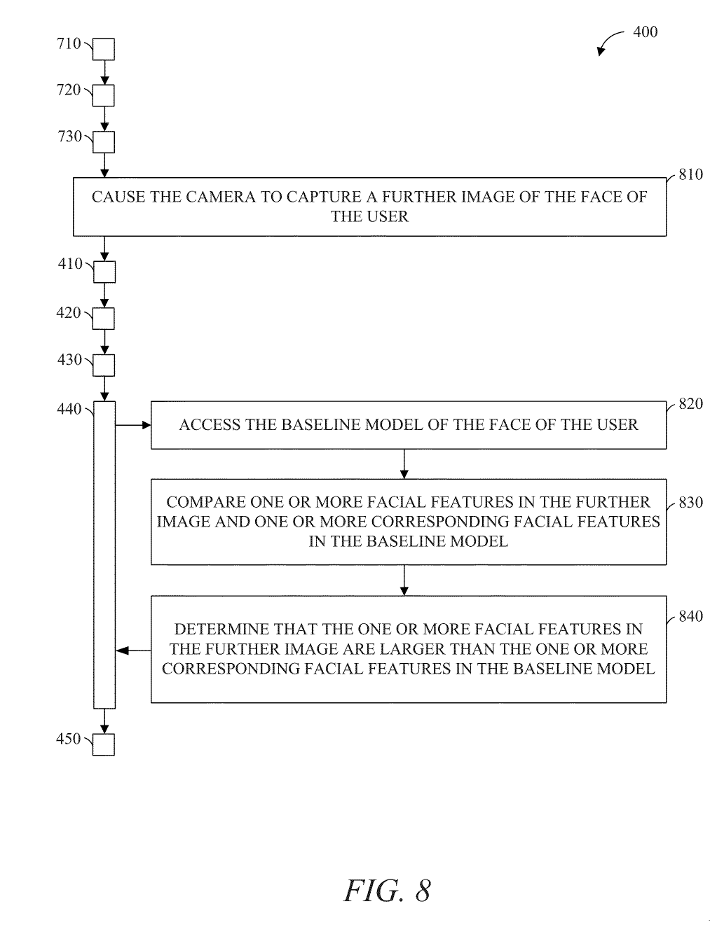

As shown in FIG. 8, the method 400 may include one or more of operations 810, 820, 830, and 840, according to example embodiments. Operation 810 may be performed before operation 410, in which the receiver module 310 receives an input associated with a user of a visual device. At operation 810, the image module 360 causes the camera associated with the visual device to capture a further (e.g., a second) image of the face of the user of the visual device. In some example embodiments, the input associated with the user includes the further image of the face of the user, and the identifying of the user (e.g., at operation 420) is based on the further image included in the input associated with the user of the visual device.

Operation 820 may be performed as part (e.g., a precursor task, a subroutine, or a portion) of operation 440, in which the analysis module 330 determines that the visual device configured based on the identity of the user is located at an impermissible distance from a portion of the face of the user. At operation 820, the analysis module 330 accesses the baseline model of the face of the user. The baseline model may be stored in a record of a database associated with the visual device (e.g., the database 128).

Operation 830 may be performed after operation 820. At operation 830, the analysis module 330 compares one or more facial features in the further image and one or more corresponding facial features in the baseline model of the face of the user. In some instances, the comparing of one or more facial features in the further image and one or more corresponding facial features in the baseline model includes computing a first distance between two points associated with a facial feature (e.g., the iris of the left eye of the user) represented in the further image, computing a second distance between the corresponding two points associated with the corresponding facial feature (e.g., the iris of the left eye of the user) represented in the baseline image, and comparing the first distance and the second distance.

Operation 840 may be performed after operation 830. At operation 840, the analysis module 330 determines that the one or more facial features in the further image are larger than the one or more corresponding facial features in the baseline model of the face of the user. In some instances, the determining that the one or more facial features in the further image are larger than the one or more corresponding facial features in the baseline model of the face of the user is based on a result of the comparing of the first distance and the second distance. If the first distance is determined to be greater than the second distance, the analysis module 330 determines that the facial feature (e.g., the iris of the left eye of the user) represented in the further image is larger than the corresponding facial feature (e.g., the iris of the left eye of the user) represented in the baseline model of the face of the user. Based on the determining that that the one or more facial features in the further image are larger than the one or more corresponding facial features in the baseline model of the face of the user, the analysis module 330 determines that the visual device is located at an impermissible distance from the portion of the face of the user.

### Example Mobile Device

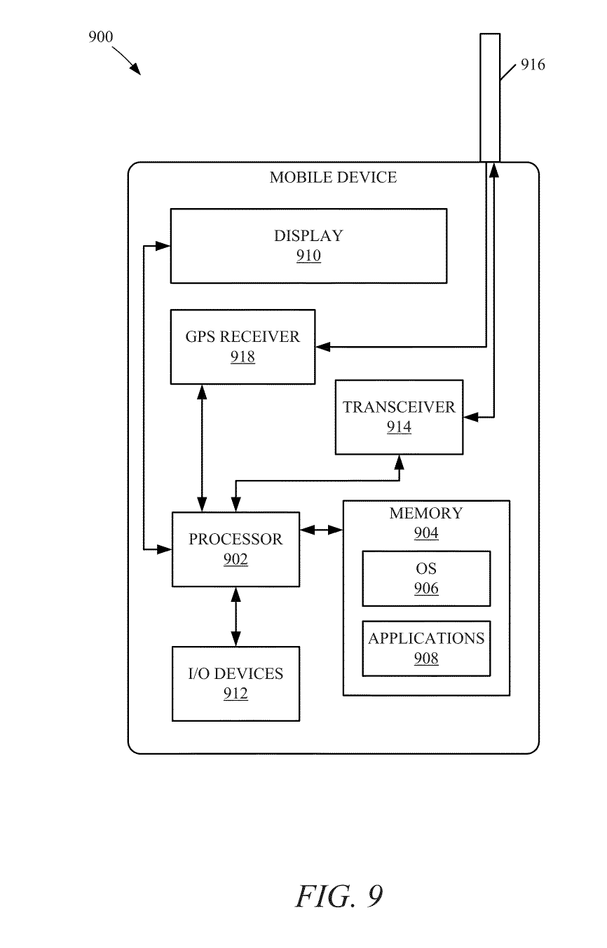

FIG. 9 is a block diagram illustrating a mobile device 900, according to some example embodiments. The mobile device 900 may include a processor 902. The processor 902 may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide LBSs to a user. The processor 902 may be coupled, either directly or via appropriate intermediary hardware, to a display 910 and to one or more input/output (I/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 902 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor 902 or other programmable processor 902) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 902 configured using software, the general-purpose processor 902 may be configured as respective different hardware-implemented modules at different times. Software may accordingly configure a processor 902, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902 or processor-implemented modules, not only residing within a single machine, but deployed across a number of machines. In some example embodiments, the one or more processors 902 or processor-implemented modules may be located in a single location (e.g., within a home environment, an office environment or as a server farm), while in other embodiments the one or more processors 902 or processor-implemented modules may be distributed across a number of locations.

The one or more processors 902 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 902, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 902 executing a computer program to perform functions by operating on input data and generating output. Operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor 902), or a combination of permanently and temporarily configured hardware may be a design choice. Below are set out hardware (e.g., machine) and software architectures that may be deployed, in various example embodiments.

### Applications

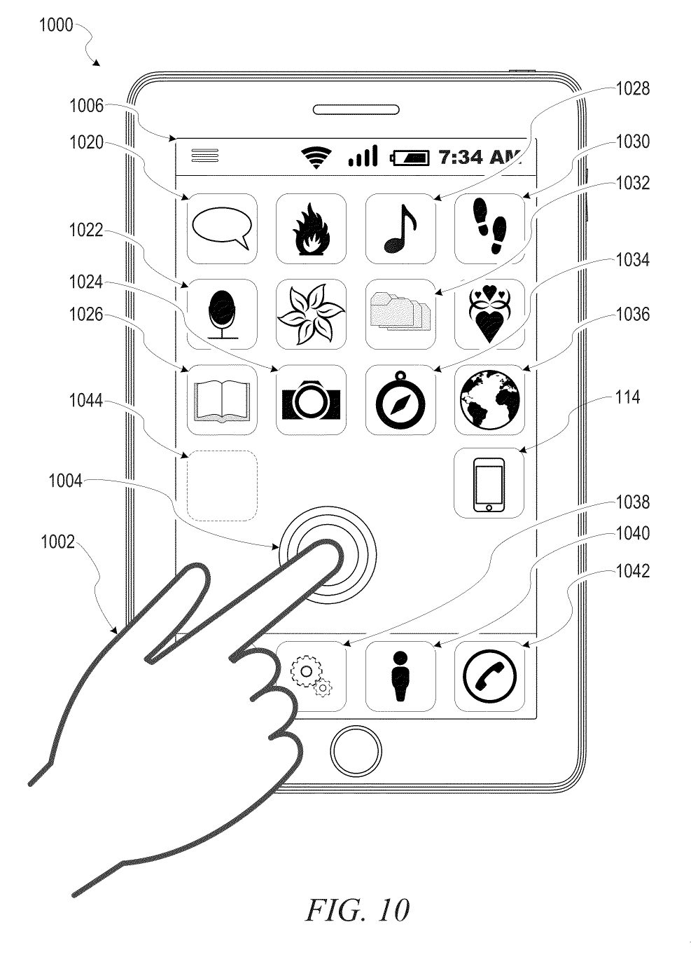

FIG. 10 illustrates an example visual device in the form of example mobile device 1000 executing a mobile operating system (e.g., iOS™, Android™, Windows® Phone, or other mobile operating systems), according to example embodiments. In example embodiments, the mobile device 1000 includes a touch screen operable to receive tactile data from a user 1002. For instance, the user 1002 may physically touch 1004 the mobile device 1000, and in response to the touch 1004, the mobile device 1000 determines tactile data such as touch location, touch force, or gesture motion. In various example embodiments, the mobile device 1000 displays a home screen 1006 (e.g., Springboard on iOS™) operable to launch applications (e.g., the client application 114) or otherwise manage various aspects of the mobile device 1000. In some example embodiments, the home screen 1006 provides status information such as battery life, connectivity, or other hardware statuses. In some implementations, the user 1002 activates user interface elements by touching an area occupied by a respective user interface element. In this manner, the user 1002 may interact with the applications. For example, touching the area occupied by a particular icon included in the home screen 1006 causes launching of an application corresponding to the particular icon.

Many varieties of applications (also referred to as “apps”) may be executing on the mobile device 1000 such as native applications (e.g., applications programmed in Objective-C running on iOS™ or applications programmed in Java running on Android™), mobile web applications (e.g., Hyper Text Markup Language-5 (HTML5)), or hybrid applications (e.g., a native shell application that launches an HTML5 session). For example, the mobile device 1000 includes a messaging app 1020, audio recording app 1022, a camera app 1024, a book reader app 1026, a media app 1028, a fitness app 1030, a file management app 1032, a location app 1034, a browser app 1036, a settings app 1038, a contacts app 1040, a telephone call app 1042, the client application 114 for controlling the mobile device 1000 based on a proximity between a user of the mobile device 1000 and the mobile device 1000, a third party app 1044, or other apps (e.g., gaming apps, social networking apps, or biometric monitoring apps), a third party app 1044.

In some example embodiments, a camera or a sensor of the mobile device 1000 may be utilized by one or more of the components described above in FIG. 3 to facilitate the controlling of the mobile device 1000 based on the proximity between the user of the mobile device 1000 and the mobile device 1000. For example, the camera of the mobile device 1000 may be controlled by the image module 360 to cause the camera to capture images of the face of the user at different times. In another example, the identity module 320 may control a biometric sensor of the mobile device 1000 based on triggering the biometric sensor to capture biometric data pertaining to the user of the mobile device 1000.

### Software Architecture

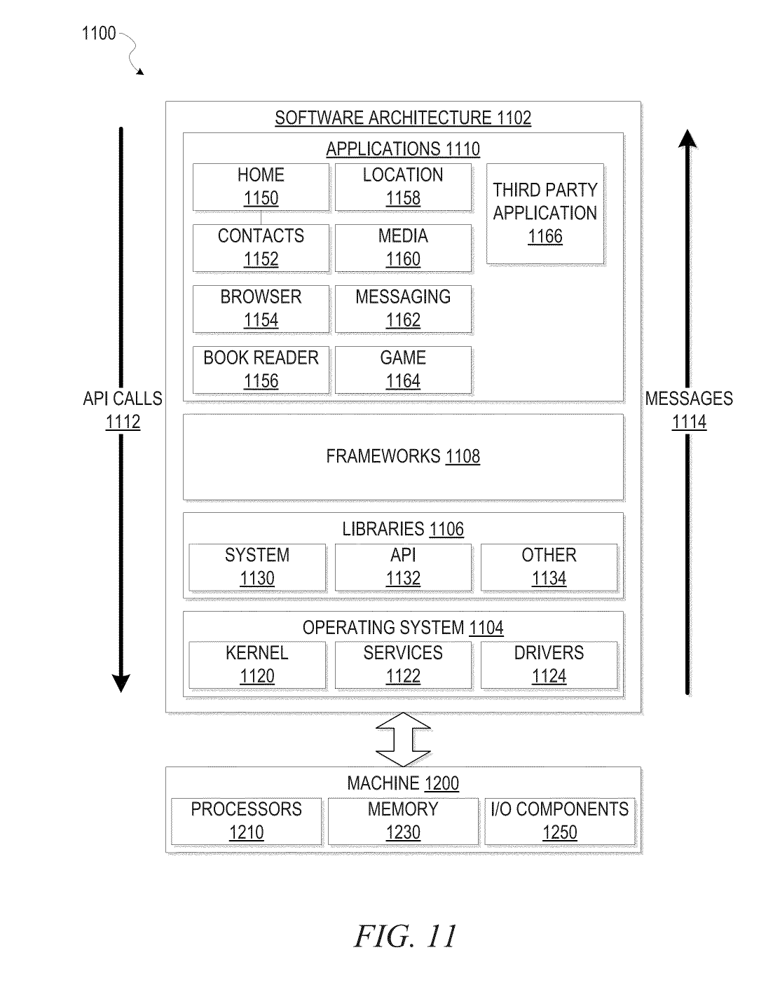

FIG. 11 is a block diagram 1100 illustrating a software architecture 1102, which may be installed on any one or more of the devices described above. FIG. 11 is merely a non-limiting example of a software architecture, and it will be appreciated that many other architectures may be implemented to facilitate the functionality described herein. The software 1102 may be implemented by hardware such as machine 1400 of FIG. 14 that includes processors 1410, memory 1430, and I/O components 1450. In this example architecture, the software 1102 may be conceptualized as a stack of layers where each layer may provide a particular functionality. For example, the software 1102 includes layers such as an operating system 1104, libraries 1106, frameworks 1108, and applications 1110. Operationally, the applications 1110 invoke application programming interface (API) calls 1112 through the software stack and receive messages 1114 in response to the API calls 1112, according to some implementations.

In various implementations, the operating system 1104 manages hardware resources and provides common services. The operating system 1104 includes, for example, a kernel 1120, services 1122, and drivers 1124. The kernel 1120 acts as an abstraction layer between the hardware and the other software layers in some implementations. For example, the kernel 1120 provides memory management, processor management (e.g., scheduling), component management, networking, security settings, among other functionality. The services 1122 may provide other common services for the other software layers. The drivers 1124 may be responsible for controlling or interfacing with the underlying hardware. For instance, the drivers 1124 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1106 provide a low-level common infrastructure that may be utilized by the applications 1110. The libraries 1106 may include system 1130 libraries (e.g., C standard library) that may provide functions such as memory allocation functions, string manipulation functions, mathematic functions, and the like. In addition, the libraries 1106 may include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1106 may also include a wide variety of other libraries 1134 to provide many other APIs to the applications 1110.

The frameworks 1108 provide a high-level common infrastructure that may be utilized by the applications 1110, according to some implementations. For example, the frameworks 1108 provide various graphic user interface (GUI) functions, high-level resource management, high-level location services, and so forth. The frameworks 1108 may provide a broad spectrum of other APIs that may be utilized by the applications 1110, some of which may be specific to a particular operating system or platform.

In an example embodiment, the applications 1110 include a home application 1150, a contacts application 1152, a browser application 1154, a book reader application 1156, a location application 1158, a media application 1160, a messaging application 1162, a game application 1164, and a broad assortment of other applications such as third party application 1166. According to some embodiments, the applications 1110 are programs that execute functions defined in the programs. Various programming languages may be employed to create one or more of the applications 1110, structured in a variety of manners, such as object-orientated programming languages (e.g., Objective-C, Java, or C++) or procedural programming languages (e.g., C or assembly language). In a specific example, the third party application 1166 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1166 may invoke the API calls 1112 provided by the mobile operating system 1104 to facilitate functionality described herein.

### Example Machine Architecture and Machine-Readable Medium

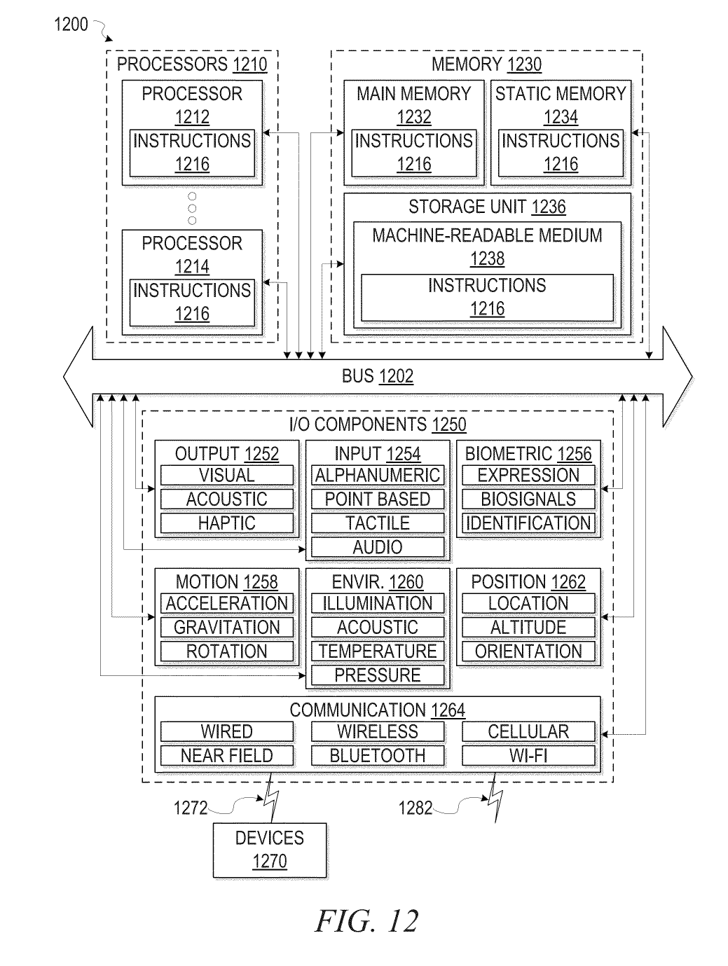

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210, memory 1230, and I/O components 1250, which may be configured to communicate with each other via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1212 and processor 1214 that may execute instructions 1216. The term “processor” is intended to include multi-core processors that may comprise two or more independent processors (also referred to as “cores”) that may execute instructions contemporaneously. Although FIG. 12 shows multiple processors, the machine 1200 may include a single processor with a single core, a single processor with multiple cores (e.g., a multi-core process), multiple processors with a single core, multiple processors with multiples cores, or any combination thereof.

The memory 1230 may include a main memory 1232, a static memory 1234, and a storage unit 1236 accessible to the processors 1210 via the bus 1202. The storage unit 1236 may include a machine-readable medium 1238 on which is stored the instructions 1216 embodying any one or more of the methodologies or functions described herein. The instructions 1216 may also reside, completely or at least partially, within the main memory 1232, within the static memory 1234, within at least one of the processors 1210 (e.g., within the processor's cache memory), or any suitable combination thereof, during execution thereof by the machine 1200. Accordingly, in various implementations, the main memory 1232, static memory 1234, and the processors 1210 are considered as machine-readable media 1238.

As used herein, the term “memory” refers to a machine-readable medium 1238 able to store data temporarily or permanently and may be taken to include, but not be limited to, random-access memory (RAM), read-only memory (ROM), buffer memory, flash memory, and cache memory. While the machine-readable medium 1238 is shown in an example embodiment to be a single medium, the term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 1250 include a wide variety of components to receive input, provide output, produce output, transmit information, exchange information, capture measurements, and so on. In general, it will be appreciated that the I/O components 1250 may include many other components that are not shown in FIG. 12. The I/O components 1250 are grouped according to functionality merely for simplifying the following discussion and the grouping is in no way limiting. In various example embodiments, the I/O components 1250 include output components 1252 and input components 1254. The output components 1252 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1254 include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In some further example embodiments, the I/O components 1250 include biometric components 1256, motion components 1258, environmental components 1260, or position components 1262 among a wide array of other components. For example, the biometric components 1256 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 include acceleration sensor components (e.g., accelerometer), gravitation sensor components, rotation sensor components (e.g., gyroscope), and so forth. The environmental components 1260 include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., machine olfaction detection sensors, gas detection sensors to detection concentrations of hazardous gases for safety or to measure pollutants in the atmosphere), or other components that may provide indications, measurements, or signals corresponding to a surrounding physical environment. The position components 1262 include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via coupling 1282 and coupling 1272, respectively. For example, the communication components 1264 include a network interface component or another suitable device to interface with the network 1280. In further examples, communication components 1264 include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a Universal Serial Bus (USB)).

Moreover, in some implementations, the communication components 1264 detect identifiers or include components operable to detect identifiers. For example, the communication components 1264 include Radio Frequency Identification (RFID) tag reader components, NFC smart tag detection components, optical reader components (e.g., an optical sensor to detect a one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Commercial Code Reduced Space Symbology (UCC RSS)-2D bar code, and other optical codes), acoustic detection components (e.g., microphones to identify tagged audio signals), or any suitable combination thereof. In addition, a variety of information can be derived via the communication components 1264, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1280 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1280 or a portion of the network 1280 may include a wireless or cellular network and the coupling 1282 may be a Code Division Multiple Access (CDMA) connection, a Global System for Mobile communications (GSM) connection, or other type of cellular or wireless coupling. In this example, the coupling 1282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

In example embodiments, the instructions 1216 are transmitted or received over the network 1280 using a transmission medium via a network interface device (e.g., a network interface component included in the communication components 1264) and utilizing any one of a number of well-known transfer protocols (e.g., Hypertext Transfer Protocol (HTTP)). Similarly, in other example embodiments, the instructions 1216 are transmitted or received using a transmission medium via the coupling 1272 (e.g., a peer-to-peer coupling) to devices 1270. The term “transmission medium” shall be taken to include any intangible medium that is capable of storing, encoding, or carrying instructions 1216 for execution by the machine 1200, and includes digital or analog communications signals or other intangible medium to facilitate communication of such software.

Furthermore, the machine-readable medium 1238 is non-transitory (in other words, not having any transitory signals) in that it does not embody a propagating signal. However, labeling the machine-readable medium 1238 as “non-transitory” should not be construed to mean that the medium is incapable of movement; the medium should be considered as being transportable from one physical location to another. Additionally, since the machine-readable medium 1238 is tangible, the medium may be considered to be a machine-readable device.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising one or more hardware processors configured to include:
a receiver module configured to receive an input associated with a user of a visual device;
an identity module configured to
determine an identity of the user of the visual device based on the input associated with the user, and
configure the visual device based on the identity of the user;
an analysis module configured to determine that the visual device configured based on the identity of the user is located at an impermissible distance from a portion of a face of the user; and
a display control module configured to cause a display of the visual device to interrupt presentation of a user interface based on the determining that the visual device is located at the impermissible distance from the portion of the face of the user.

2. The system of claim 1, wherein the input received at the visual device includes a visual input that represents one or more facial features of the user of the visual device, and
wherein the identity module determines the identity of the user based on the one or more facial features of the user.

3. The system of claim 1, wherein the input received at the visual device includes biometric data associated with the user, the biometric data being captured by the visual device, and
wherein the identity module determines the identity of the user based on the biometric data associated with the user.

4. The system of claim 1, wherein the configuring of the visual device includes selecting, based on the identity of the user, a control rule for controlling the visual device, the control rule specifying a threshold proximity value, and
wherein the analysis module determines that the visual device configured based on the identity of the user is located at the impermissible distance from the portion of the face of the user by performing operations including:
identifying a distance value between the visual device and the portion of the face of the user, and
determining that the distance value between the visual device and the portion of the face of the user is below the threshold proximity value.

5. The system of claim 1, wherein the input associated with the user of the visual device is a first input received at a first time,
wherein the analysis module determines that the visual device is located at the impermissible distance from the portion of the face of the user based on the first input received at the first time,
wherein the receiver module is further configured to receive, at a second time, a second input associated with the user of the visual device,
wherein the identity module is further configured to confirm that the identity of the user of the visual device is the same, based on the second input received at the second time,
wherein the analysis module is further configured to determine that the visual device is located at a permissible distance from the portion of the face of the user, based on the second input received at the second time, and
wherein the display control module is further configured to cause the display of the visual device to resume presentation of the user interface, based on the determining that the visual device is located at the permissible distance from the portion of the face of the user.

6. The system of claim 1, further comprising:
a communication module configured to provide instructions to the user to position the face of the user at a distance equal to the threshold proximity value;
an image module configured to
cause a camera associated with the visual device to capture an image of the face of the user located at the distance equal to the threshold proximity value, and
generate a baseline model of the face of the user based on the captured image.

7. The system of claim 6, wherein the image module is further configured to cause the camera to capture a further image of the face of the user, the input associated with the user including the further image of the face of the user, and
wherein the analysis module determines that the visual device configured based on the identity of the user is located at the impermissible distance from a portion of the face of the user by performing operations including:
accessing the baseline model of the face of the user,
comparing one or more facial features in the further image to one or more corresponding facial features in the baseline model of the face of the user, and
determining that the one or more facial features in the further image are larger than the one or more corresponding facial features in the baseline model of the face of the user.

8. A method comprising:
at a visual device, receiving an input associated with a user of the visual device;
determining an identity of the user of the visual device based on the input associated with the user;
configuring the visual device based on the identity of the user;
determining that the visual device configured based on the identity of the user is located at an impermissible distance from a portion of the face of the user;
causing, using one or more hardware processors, a display of the visual device to interrupt presentation of a user interface based on the determining that the visual device is located at the impermissible distance from the portion of the face of the user.

9. The method of claim 8, wherein the input received at the visual device includes a visual input that represents one or more facial features of the user of the visual device, and
wherein the determining of the identity of the user is based on the one or more facial features of the user.

10. The method of claim 8, wherein the input received at the visual device includes login data associated with the user, the login data entered at the visual device by the user of the visual device, and
wherein the determining of the identity of the user is based on the login data associated with the user.

11. The method of claim 8, wherein the input received at the visual device includes biometric data associated with the user, the biometric data being captured by the visual device, and
wherein the determining of the identity of the user is based on the biometric data associated with the user.

12. The method of claim 8, wherein the configuring of the visual device includes selecting, based on the identity of the user, a control rule for controlling the visual device, the control rule specifying a threshold proximity value, and
wherein the determining that the visual device configured based on the identity of the user is located at the impermissible distance from the portion of the face of the user includes:
identifying a distance value between the visual device and the portion of the face of the user, and
determining that the distance value between the visual device and the portion of the face of the user is below the threshold proximity value.

13. The method of claim 8, wherein the input associated with the user of the visual device is a first input received at a first time,
wherein the determining that the visual device is located at the impermissible distance from the portion of the face of the user is based on the first input received at the first time; and further comprising:
receiving, at a second time, a second input associated with the user of the visual device;
confirming that the identity of the user of the visual device is the same, based on the second input received at the second time;
determining that the visual device is located at a permissible distance from the portion of the face of the user, based on the second input received at the second time; and
causing the display of the visual device to resume presentation of the user interface, based on the determining that the visual device is located at the permissible distance from the portion of the face of the user.

14. The method of claim 8, further comprising:
causing the user to position the face of the user at a distance equal to the threshold proximity value;
causing a camera associated with the visual device to capture an image of the face of the user located at the distance equal to the threshold proximity value;
generating a baseline model of the face of the user based on the captured image.

15. The method of claim 14, wherein the determining that the distance value between the visual device and the portion of the face of the user is below the threshold proximity value includes:
causing the camera to capture a further image of the face of the user, the input associated with the user including the further image of the face of the user;
accessing the baseline model of the face of the user;
comparing one or more facial features in the further image and one or more corresponding facial features in the baseline model of the face of the user; and
determining that the one or more facial features in the further image are larger than the one or more corresponding facial features in the baseline model of the face of the user.

16. A non-transitory machine-readable medium comprising instructions that, when executed by one or more processors of a machine, cause the machine to perform operations comprising:
at a visual device, receiving an input associated with a user of the visual device;
determining an identity of the user of the visual device based on the input associated with the user;
configuring the visual device based on the identity of the user;
determining that the visual device configured based on the identity of the user is located at an impermissible distance from a portion of the face of the user;
causing, using one or more hardware processors, a display of the visual device to interrupt presentation of a user interface based on the determining that the visual device is located at the impermissible distance from the portion of the face of the user.

17. The non-transitory machine-readable medium of claim 16, wherein the configuring of the visual device includes selecting, based on the identity of the user, a control rule for controlling the visual device, the control rule specifying a threshold proximity value, and
wherein the determining that the visual device configured based on the identity of the user is located at the impermissible distance from the portion of the face of the user includes:
identifying a distance value between the visual device and the portion of the face of the user, and
determining that the distance value between the visual device and the portion of the face of the user is below the threshold proximity value.

18. The non-transitory machine-readable medium of claim 16, wherein the input associated with the user of the visual device is a first input received at a first time,
wherein the determining that the visual device is located at the impermissible distance from the portion of the face of the user is based on the first input received at the first time; and wherein the operations further comprise:
receiving, at a second time, a second input associated with the user of the visual device;
confirming that the identity of the user of the visual device is the same, based on the second input received at the second time;
determining that the visual device is located at a permissible distance from the portion of the face of the user, based on the second input received at the second time; and
causing the display of the visual device to resume presentation of the user interface, based on the determining that the visual device is located at the permissible distance from the portion of the face of the user.

19. The non-transitory machine-readable medium of claim 16, wherein the operations further comprise:
causing the user to position the face of the user at a distance equal to the threshold proximity value;
causing a camera associated with the visual device to capture an image of the face of the user located at the distance equal to the threshold proximity value;
generating a baseline model of the face of the user based on the captured image.

20. The non-transitory machine-readable medium of claim 19, wherein the determining that the distance value between the visual device and the portion of the face of the user is below the threshold proximity value includes:
causing the camera to capture a further image of the face of the user, the input associated with the user including the further image of the face of the user;
accessing the baseline model of the face of the user;
comparing one or more facial features in the further image and one or more corresponding facial features in the baseline model of the face of the user; and determining that the one or more facial features in the further image are larger than the one or more corresponding facial features in the baseline model of the face of the user.
